(19) United States
(12) Patent Application Publication
(10) Pub. No.: US 2008/0212130 A1
(43) Pub. Date: Sep. 4, 2008

(54) DATA FILE COMPRESSION APPARATUS AND METHOD THEREOF

(75) Inventor: Ji Won JUNG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/027,304

(22) Filed: Feb. 7, 2008

(30) Foreign Application Priority Data
Feb. 21, 2007 (KR) 2007-17506

(51) Int. Cl. G06F 3/12; G06F 17/30

(52) U.S. Cl. 358/1.15; 707/101; 707/E17.009

(57) ABSTRACT

An apparatus and method for compressing data. The apparatus can properly select any one of two compression codecs (i.e., the lossless codec and the lossy codec) according to compression capacities, compress the print data using the selected compression codec, and store the compressed data in the memory, such that an overall compression rate is decreased and the memory efficiency increases. Although the data is compressed by the lossy codec and a low compression rate is provided, the user may not notice the deterioration of the image quality. The method for compressing data includes compressing print data using a first codec; storing the compressed data in a memory; monitoring a compression capacity of the stored data; stopping the compression using the first codec based on the compression capacity, and re-compressing the print data using a second codec; and storing the re-compressed data in the memory.

### CROSS-REFERENCE TO RELATED APPLICATION

This application claims all benefits accruing under 35 U.S.C. §119 from Korean Patent Application No. 2007-17506, filed in the Korean Intellectual Property Office on Feb. 21, 2007, the disclosure of which is incorporated herein by reference.

### BACKGROUND OF THE INVENTION

1. Field of the Invention

Aspects of the present invention relate to a data file compression apparatus and a method thereof, and more particularly to an apparatus and method for compressing data to enhance a printing quality of an image printed by a printing device.

2. Related Art

File compression or data compression used in an image forming apparatus involves encoding and decoding data using a smaller number of bits than the initial data, so as to reduce the size of a data memory area. Data compression schemes are generally classified into lossless compression schemes and lossy compression schemes.

According to lossless compression, when compressed data is decompressed, the bits of the uncompressed data are identical to the bits of initial data created before the data compression. Lossless compression can compress the size of a file to 40% of the original file size.

According to lossy compression, when the compressed data is decompressed, some data is lost, such that the uncompressed data is different from initial data created before the data compression. Lossy compression can compress the size of a file to 5% of an original file size.

Due to the above-mentioned characteristics, lossless compression is generally used to compress important data (e.g., a sentence, code data, or numerical data). Lossy compression is generally used to compress multimedia data (e.g., video and audio data).

If the image forming apparatus performs lossless compression on the image, the compression efficiency is decreased and the image quality increases. If the image forming apparatus performs lossy compression, the compression efficiency increases and the image quality decreases.

If the image forming apparatus receives data to be printed from a host computer or an external device, the image forming apparatus compresses data using a coder/decoder (codec), which can be software or hardware, included in the image forming apparatus, and stores the compressed data in a memory, so as to increase data processing efficiency. In this case, lossless compression is used as the compression method. Due to the characteristics of lossless compression, compression efficiency decreases and the image quality increases. As a result, the image forming apparatus requires a large-capacity memory.

In order to solve the above-mentioned problems, if the compression capacity of data is higher than a capacity of the memory, a conventional image forming apparatus lowers the printing quality of the image to be printed, and prints the image at the low printing quality.

However, the above-mentioned conventional image forming apparatus compresses data using a lossless codec, such that the compression rate is low and image quality is high, resulting in an increased memory requirement. If the capacity of the compression data is higher than a predetermined capacity, the conventional image forming apparatus may unavoidably print the compressed data at a low image quality.

### SUMMARY OF THE INVENTION

Aspects of the present invention provide an apparatus and method for compressing data, if compression capacity is higher than a predetermined capacity while data to be printed is compressed according to a lossless compression method and is then stored in a memory, which re-compresses the data using another compression method, such that image quality can be increased.

According to an aspect of the present invention, a method of compressing data is provided. The method comprises compressing print data using a first codec; storing the compressed data in a memory; monitoring a compression capacity of the stored data; stopping the compression using the first codec based on the compression capacity, and re-compressing the print data using a second codec; and storing the re-compressed data in the memory.

According to another aspect of the present invention, an apparatus to compress data is provided. The apparatus comprises a first codec to compress print data; a second codec to compressing the print data; a memory to store data compressed by the first codec and the second codec; and a compression capacity monitoring unit to monitor a compression capacity of the data stored in the memory, stop the compression using the first codec based on the monitored compression capacity, to re-compress the print data using the second codec, and to re-store the re-compressed data in the memory.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating a data compression apparatus according to an example embodiment of the present invention;

FIG. 2 is a block diagram illustrating a lossless codec unit shown in FIG. 1; and

FIG. 3 is a flow chart illustrating a data compression process according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

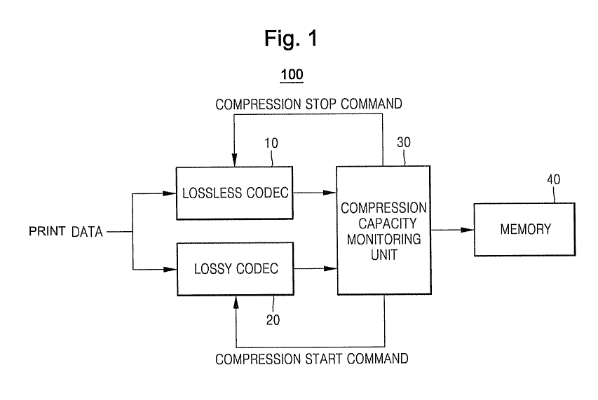

FIG. 1 is a block diagram illustrating a data compression apparatus 100 according to an example embodiment of the present invention. The data compression apparatus 100 includes a lossless codec 10, a lossy codec 20, a compression capacity monitoring unit 30, and a memory 40. As shown in FIG. 1, the lossless codec 10 is connected in parallel to the lossy codec 20. The compression capacity monitoring unit 30 is connected to the input terminal of the memory 40. According to other aspects of the invention, the data compression apparatus 100 may include additional and/or different units. Similarly, the functionality of two or more of the above units may be combined into a single component.

The compression capacity monitoring unit 30 monitors the compression capacity stored in the memory 40. If the compression capacity is higher than a predetermined capacity, the compression capacity monitoring unit 30 outputs a specific command to the lossless codec 10 to interrupt the compression operation of the lossless codec 10, and outputs another command to the lossy codec 20 to initiate a compression operation using the lossy codec 20.

Generally, data is initially compressed according to the lossless compression, and is then stored in the memory 40. However, according to other aspects of the invention, data may be initially compressed using lossy compression.

If the magnitude of the compressed data is higher than the capacity of the memory 40, the compression-capacity monitoring unit 30 monitors the capacity of the compressed data stored in the memory in real time. If the capacity of the compressed data is higher than a predetermined capacity, the lossless compression based on the lossless codec 10 is interrupted, the lossy codec 20 starts lossy compression on the initial data, and the lossless-compressed data is overwritten by the lossly-compressed data. In this case, the data is compressed using different codecs. The categories of codecs used may be recorded in a header part of the compressed data based on a decoding time.

Any one of two compression codecs may be selected according to the compression capacities, and the selected compression codec is stored in the memory, such that an overall compression rate is decreased and memory efficiency increases, resulting in increased printing quality of the image forming apparatus.

As described above, if the image forming apparatus prints data using the lossless compression method, the compression efficiency is decreased and the image quality increases due to the characteristics of the lossless compression method. As a result, if the compression capacity is higher than a predetermined capacity, the image forming apparatus may unavoidably print data at a low printing quality.

In order to solve the above-mentioned problems, if the compression capacity is higher than a predetermined capacity, the image forming apparatus re-compresses the data using the lossy codec 20. As a result, the compression capacity is lowered, the memory efficiency increases, and the printing quality of the image forming apparatus also increases. Although the data is compressed according to the lossy codec, the user may not notice the reduced quality of the image quality if the data is compressed at a low compression rate.

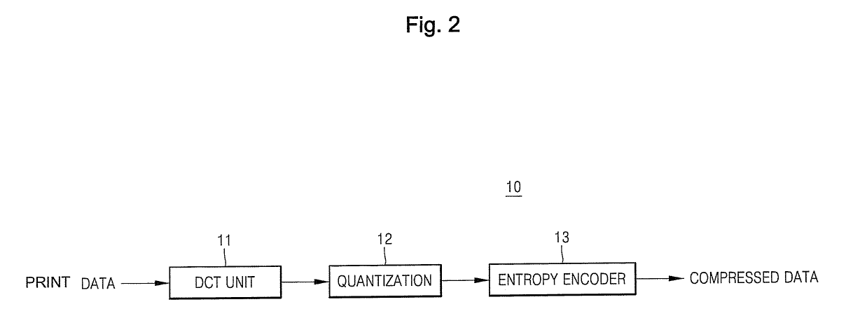

FIG. 2 is a block diagram illustrating a lossless codec shown in FIG. 1. The lossless codec 10 sequentially performs a DCT (Discrete Cosine Transform) process, a quantization process, an entropy encoding process, such that the print data is compressed. The DCT unit 11 performs the DCT process on pixels of the print data in block units. The quantization unit 12 performs the quantization process on the DCT coefficient acquired from the DCT unit 11, expresses some representative values associated with the quantized result, and outputs quantization data. The entropy encoder 13 performs the entropy encoding process on the quantization data acquired from the quantization unit 12, and generates compressed data.

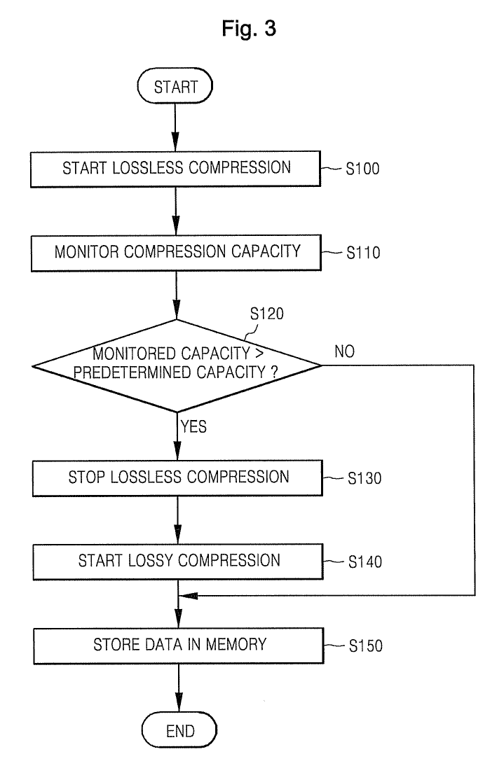

FIG. 3 is a flow chart illustrating a data compression process according to an example embodiment of the present invention. The lossless codec 10 compresses data according to the lossless compression method at block S100. The compressed data is stored in the memory 40.

The compression-capacity monitoring unit 30 monitors the compression capacity stored in the memory 40 at block S110. The compression-capacity monitoring unit 30 compares the monitored compression capacity with a predetermined capacity, and determines whether the monitored compression capacity is higher than the predetermined capacity at block S120. If the monitored compression capacity is higher than the predetermined capacity, the compression-capacity monitoring unit 30 stops operations of the lossless codec 10 at block S130, interrupting the lossless compression. The compression-capacity monitoring unit 30 compresses data using the lossy codec 20 at block S140.

The lossy-compressed data is stored in the memory 40 at block S150. The compressed data stored in the memory is printed onto a printable medium by the image forming apparatus. The memory efficiency and the printing quality can be increased by lowering the compression capacity. If compression scheme having a high compression rate is not employed by the lossy codec 20, the user may not notice the reduced image quality.

As is apparent from the above description, aspects of the present invention may select any one of two compression codecs (i.e., the lossless codec 10 and the lossy codec 20) according to compression capacities, compress the print data using the selected compression codec, and store the compressed data in the memory, such that an overall compression rate is decreased whereas the memory efficiency increases. Although the data is compressed by the lossy codec 20 and a low compression rate is provided, the user may not notice the reduced image quality.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), DVDs, CDs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, although the data compression apparatus has been described in conjunction with an image forming apparatus, the data compression apparatus may be used with any device using compression schemes. Similarly, the compression capacity monitoring unit may be incorporated into a controller that controls the operation of the image forming apparatus (or other device). In addition, although two codecs have been described, a plurality of codecs may be used. Accordingly, it is intended, therefore, that the present invention not be limited to the various example embodiments disclosed, but that the present invention includes all embodiments falling within the scope of the appended claims.

What is claimed is:

1. A method of compressing data, comprising:
compressing print data using a first codec;
storing compressed data in a memory;
monitoring a compression capacity of stored data;
stopping the compression using the first codec based on the compression capacity, and re-compressing the print data using a second codec; and
storing re-compressed data in the memory.

2. The method according to claim 1, further comprising:
stopping the compression based on the first codec if the monitored compression capacity is equal to or higher than a predetermined capacity.

3. The method according to claim 2, wherein the predetermined capacity is a memory capacity.

4. The method according to claim 1, wherein the first codec is a lossless codec.

5. The method according to claim 1, wherein the second codec is a lossy codec.

6. An apparatus to compress data comprising:
a first codec to compress print data;
a second codec to compress the print data;
a memory to store data compressed by the first codec and the second codec; and
a compression-capacity monitoring unit to monitor a compression capacity of the data stored in the memory, to stop the compression based on the first codec based on the monitored compression capacity, to re-compress the print data using the second codec, and to store the re-compressed data in the memory.

7. The apparatus according to claim 6, wherein the compression-capacity monitoring unit compares the monitored compression capacity with a predetermined capacity, and stops the compression based on the first codec if the monitored compression capacity is equal to or greater than the predetermined capacity.

8. The apparatus according to claim 7, wherein the predetermined capacity is a capacity of the memory.

9. The apparatus according to claim 6, wherein the first codec is a lossless codec.

10. The apparatus according to claim 6, wherein the second codec is a lossy codec.

11. The method according to claim 1, wherein the re-compressed data is stored in the memory by overwriting the compressed data.

12. The apparatus according to claim 6, wherein the compression capacity monitoring unit re-stores the re-compressed data in the memory by overwriting the compressed data.

13. An image forming apparatus comprising:
a first codec to compress print data using a first compression scheme;
a second codec to compress the print data using a second compression scheme;
a memory to store data compressed by the first codec and the second codec;
a compression capacity monitoring unit to monitor a compression capacity of the memory, to stop the operation of the first codec based on the compression capacity, and to start operation of the second codec based on the compression capacity; and
a printing unit to form an image corresponding to the compressed data onto a printable medium.

14. The image forming apparatus of claim 13, wherein the compression capacity monitoring unit stops the operation of the first codec if the compression capacity is greater than or equal to a predetermined capacity.

15. The image forming apparatus of claim 14, wherein the predetermined capacity is a capacity of the memory.

16. The image forming apparatus of claim 13, wherein the first compression scheme is a lossless compression scheme.

17. The image forming apparatus of claim 13, wherein the second compression scheme is a lossy compression scheme.

18. A computer readable medium comprising instructions that, when executed by a data compression apparatus, cause the data compression apparatus to perform the method of claim 1.

19. A data compression apparatus, comprising:
a plurality of codecs to compress data;
a memory to store the compressed data; and
a controller to monitor a compression capacity of the memory, to stop the operation of one of the plurality of codecs based on the compression capacity, and to start operation of another one of the plurality of codecs, based on the compression capacity.

20. The data compression apparatus of claim 19, wherein the controller stops the operation of the one of the plurality of codecs if the compression capacity is greater than or equal to a capacity of the memory.
